(19) United States
(12) Patent Application Publication
(10) Pub. No.: US 2022/0037923 A1
(43) Pub. Date: Feb. 3, 2022

(54) COMPACT SURVEILLANCE SYSTEM

(71) Applicant: Brendan Hyland, Edinburgh (GB)

(72) Inventor: Brendan Hyland, Edinburgh (GB)

(21) Appl. No.: 17/366,046

(22) Filed: Jul. 2, 2021

Related U.S. Application Data
(63) Continuation of application No. 17/327,765, filed on May 24, 2021.
(60) Provisional application No. 63/060,141, filed on Aug. 3, 2020.

(51) Int. Cl. H02J 50/10; H02J 50/00

(52) U.S. Cl. CPC H02J 50/10; H04W 84/18; H02J 50/001

(57) ABSTRACT

A compact surveillance system (CSS) includes a power input configured to provide power to the system; one or more sensors configured to measure a measurand; a receiver configured to receive an external signal; and a processor configured to generate information, the processor being in electrical communication with: the one or more sensors; an information storage device configured to store the information; a source transducer configured to transfer the information; wherein the information is generated based on the measurand so as to reduce a transfer energy.

### CROSS-REFERENCE TO RELATED APPLICATIONS

This application claims the priority benefit of all of the following: a Continuation of patent application Ser. No. 17/327,765, filed on May 24, 2021, which claims the priority benefit of U.S. Provisional Patent Application No. 63/060,141, filed on Aug. 3, 2020.

### TECHNICAL FIELD

The present disclosure relates to surveillance systems. In particular, the present disclosure relates to compact surveillance systems that include a Loosely Coupled Transformer (LCT).

### BACKGROUND

Surveillance is the monitoring of behaviour, activities, or information for the purpose of information gathering, influencing, managing or directing. This can include the use of sensors locate near to or at a distance from a life form, location, asset or equipment to be monitored. It can also include simple technical methods, such as human intelligence gathering and postal interception.

Surveillance systems are used in a wide number of applications including but limited to promote safety, security, health and wellbeing, to protect the environment, to enhance operational efficiency or to reduce costs. Typically, a surveillance system includes one or more sensors that are mounted in a location sought to be monitored. Data from sensors may be sent immediately by wired or wireless communications across a network to a monitoring system for real time monitoring by personnel and/or an automated or autonomous system. The sensor data may be processed at or near the sensors to derive information which is sent to a monitoring system which may be cloud based. Data that has been processed locally by algorithms may provide information used to improve the performance of other attributes of the surveillance system.

Surveillance systems suffer several drawbacks. One drawback is remote surveillance systems which are powered by a temporary source such as a battery and which use wireless communications suffer from the cost and operational complexity of battery replacement. The used working life of a battery-powered system is affected by the number of sensors used, sensor duty cycle, and the frequency of communications across a wireless network and the quantity of data transferred or transmitted and practical considerations of local recharging using solar or other means.

The energy efficiency of most systems is less than what might be desired, reducing the usefulness of such systems. Increasing the energy efficiency of surveillance systems, however, requires one or more of optimising sensor energy consumption, optimising sampling rate and optimising the quantity and frequency of information transfer. Such adjustments to sampling frequency and data transmission or information transfer may lead impact resolution and/or latency of the surveillance system.

The present disclosure has been devised to mitigate or overcome at least some of the above-mentioned problems.

### SUMMARY

An object of the present invention is to provide a compact surveillance system with Loosely Coupled Transformer (LCT) configured to transfer.

Information.

Another object of the present invention is to provide a compact surveillance system with an LCT that includes a supercapacitor.

Yet another object of the present invention is to provide a compact surveillance system with an LCT that includes a source transducer including a resonant primary coil.

A further object of the present invention is to provide a compact surveillance system with an LCT that includes a sink transducer including a resonant secondary coil and a rekoil sink.

Still another object of the present invention is to provide a compact surveillance system with an LCT that includes impulsive interference suppression,

Another object of the present invention is to provide a compact surveillance system with an LCT that includes at least one of a source transducer and a sink transducer.

Yet another object of the present invention is to provide a compact surveillance system with an LCT with at least one of a source transducer and a sink transducer is located in a fluid.

Still a further object of the present invention is to provide a compact surveillance system with an LCT wherein a minimum of one of power and information is transferred from source to a remote sink.

### BRIEF DESCRIPTION OF THE DRAWINGS

FIG. 1 is a compact surveillance system according to a first aspect of the present invention.

FIG. 2 is a network of compact surveillance systems of FIG. 1, according to a second aspect of the present invention.

FIG. 3 is a further network of compact surveillance systems.

FIG. 4 is a further network of compact surveillance systems.

FIG. 5 is a further network of compact surveillance systems.

FIG. 6 is a further network of compact surveillance systems.

FIG. 7 is a further network of compact surveillance systems.

### DETAILED DESCRIPTION

In various embodiments, a compact surveillance system (CSS) 10 is provided with an LCT. In one embodiment, a power input is configured to provide power to the system 10. In one embodiment, one or more sensors 42 measures data from a measurand. In one embodiment, a transducer unit links with an external signal. In one embodiment, a processor 16 generates information. In one embodiment, the processor 16 is in electrical communication with: the one or more sensors 42; an information storage device 15 configured to store the information; and a transducer unit configured to transfer the information. In one embodiment, information is generated based on the measurand so as to reduce a transfer energy.

In one embodiment, the measurand may include but not limited to: above water, below water, below ground environments; infrastructure including but not limited to electrical cables, pipes, flowlines, cages, protection systems, foundations, bridges, roads, fixed and floating structures; buildings including but not limited to industrial, civic, and residential; below ground industrial processes; manned and unmanned vehicles; fauna and flora, including but not limited to humans, land, air and sea animals; environments including but not limited to underwater, underground, sea water, fresh water, above ground and above water.

As a non-limiting example, information is derived from data that has been processed, organised, structured or subject to interpretation by a logic system to make the data meaningful or useful. Compressing data does not in itself result in information. Information provides context for data.

In one embodiment, the system 10 is useful for surveillance in environments which present information transfer challenges and with sensing apparatus which are required to function for a long time between maintenance events, or without any maintenance. This is typically the case for underwater surveillance. As a non-limiting example, the system can be used to monitor seismic activity. As a non-limiting example, the system can be used to monitor asset integrity. As a non-limiting example, the system can be used to monitor system performance. As a non-limiting example, the system can be used to monitor the environment. As a non-limiting example, the system can be used to monitor climate change. As a non-limiting example, the system can be used to monitor biodiversity. As a non-limiting example, sensing apparatus functions reliably for an extended period of time, typically a number of years, without maintenance or the ability to replace or to recharge batteries through a mains-powered connection. As a non-limiting example, it is vital for the system 10 to be energy efficient. Related to this, when measurement data or information derived therefrom is to be transferred through lossy mediums, for example through water, conventional apparatus may consume large amounts of power, requiring the use of large batteries if wired power connections are to be avoided. Thus, the present invention advantageously provides a reliable CSS which can operate and transfer measurement data or information derived therefrom with a high level of energy efficiency, thereby reducing wasteful energy consumption and a requirement to use large batteries.

As non-limiting examples, system 10 can be fixed or mobile. The system 10 may be wired or wireless. The system 10 can include a low power sink circuit having a limiting comparator with high gain configured to ensure each active power level has the same sensitivity. In some embodiments, the system 10 includes a secure passive monitoring system 10, wherein a minimum of two frequencies and a minimum of one tone length is detectable using a limiting comparator circuit for activation of the processor 16. In some embodiments, the system 10 includes a minimum of two frequency settings, each having a tone, wherein the tones are configured to be detected at each of the required frequencies using a limiting comparator circuit for activation of the processor 16. As a non-limiting example, a probability of false wake-up due to interference, and unauthorised access reduces with the number of frequency settings. In some embodiments, the processor 16 is configured to set and adapt a duty cycle to control the transfer of information using a minimum of two transfer methods. For example, the duty cycle may be adapted based on criteria other than signal quality, range or bandwidth.

In some embodiments, the system 10 operates according to an adjustable energy setting. The energy setting provides a sensor duty cycle, a sensor energy, a pre-processing algorithm, a processing algorithm, a frequency, a transducer energy, a transducer gain, and a transducer bandwidth.

In one embodiment, the one or more sensors 42 are selected from the range of: a temperature sensor; a multi-frequency sensor; a location sensor; an Eddy Current corrosion sensor; a cathodic protection sensor; an ultrasonic thickness sensor; a pH sensor, a water density sensor; a turbidity sensor; a light sensor; an oxygen sensor; a bio-fouling build-up sensor; a water conductivity sensor; a water salinity sensor; a water density sensor; a water current sensor; a strain sensor; a chemical composition sensor; an electromagnetic field sensor; a magnetic field sensor; a gravitational field sensor; a flow sensor; a flow velocity sensor; a speed-of-sound sensor; a speed-of-EM propagation sensor; a speed-of-magnetic field propagation sensor; a light sensor; a pressure sensor; an accelerometer; an acoustic-emission sensor; and an image sensor. Accordingly, the processor 16 can operable to generate information such as: a speed-of-sound; a speed-of-EM field propagation; a speed-of-magnetic field propagation; a pH; an oxygen content; a corrosion; fatigue; a movement; vibration characteristics; a density; a conductivity; a salinity; a chemical composition; a velocity; a current; a biofouling; a turbidity; a location; an alignment; and a corrosion.

In some embodiments, the sensor is a low power sensor operable to measure the measurand at a lower sensitivity than a standard sensor. Advantageously, less power may be used. In some embodiments, the sensor may be a remote sensor configured to transfer measured data to the system 10, wherein the field strength at the surveillance system due to the 1/r component is greater than the field due to the 1/r² component and the field strength at the remote node due to the 1/r component is greater than the field due to the 1/r³ component.

In some embodiments, the processor 16 generates the information based on the measurand using one or more selected from the range of: a data model; a digital twin; a machine learning algorithm; and an artificial intelligence algorithm. In some embodiments, the information is generated in order to maximise energy efficiency at the expense of latency. In some embodiments, the information is compressed by the processor 16. In alternative embodiments, the information is not compressed by the processor 16. In some embodiments, the processor 16 is operable to execute a pre-processing algorithm configured to improve one or more of: energy efficiency; resilience; security; and latency for a given range. For example, the pre-processing algorithm may include one or more selected from the range of: data cleansing or cleaning; data editing; data wrangling; data de-duplication; data integration; data transformation; data reduction; data discretization; data sampling; and data resampling. The information may comprise one or more selected from the range of: an image feature; a characteristic of the measurand; a development; a status; a health; a threshold; an alarm; a location; a movement; and a derived change of the measurand.

In one embodiment, the LCT includes: a sink transducer 25 configured to convert the external signal into an electrical signal. In some embodiments, the sink transducer incorporates a rekoil configured to convert energy of an external signal into electrical energy. Preferably, the rekoil is further configured to capture and convert ambient energy into electrical energy. The ambient energy may be one or more of an electromagnetic field, a magnetic field, an acoustic wave, and a temperature differential.

In one embodiment, LCT includes an energy storage unit configured to store the electrical energy generated by the rekoil. The energy storage unit may include two or more accumulators for hybrid energy storage. For example, the accumulators may be one or more selected from the range of: a primary cell, a secondary cell, a capacitor, a supercapacitor, and an inductor. A size of the energy storage unit may be reduced due to the rectenna. This reduction in energy storage unit size leading to an improved compactness and a reduction in materials used for construction which brings benefits in the form of one or more of reduced environmental footprint, cost, and reliability.

In one embodiment, the sink transducer 25 is a smart transducer. Alternatively, or additionally, the sink transducer 25 includes one or more selected from the range of: impulsive interference suppression; software defined radio; adaptive radio; cognitive radio; and a cognitive radio sensor network. In this way, information transfer energy efficiency and performance, resilience, and compactness of the system 10 may improve. Additionally or alternatively, the sink transducer 25 may comprise one or more selected from the range of: coil; an antenna; an intelligent antenna; a loop antenna; a photodetector; a photoresistor; a phototransistor; and a photomultiplier.

In one embodiment, the device further includes a data storage device 15 configured to store the measurand.

In one embodiment the source includes: a source having a modulator 18 configured to modulate the information on to a carrier signal; and a source transducer 22 configured to produce a field comprising the modulated signal. In some embodiments, the source transducer 22 is a smart transducer 22. The smart transducer 22 may comprise a shield configured to reduce interference due to an electromagnetic field. Additionally or alternatively, the smart transducer 22 may comprise: a transmit loop antenna with a minimum of one of a maximum of 2 turns, and manufactured of low resistance and electrically insulated tube, and resonated, and maintained in resonance by varying a minimum of one of power and frequency and capacitance and signal processing. Additionally or alternatively, the source may comprise one or more selected from the range of: a loosely coupled transformer, an acoustic transmitter, an optical transmitter, a radio transmitter, a cognitive radio transmitter; and a magneto-inductive transmitter. Additionally or alternatively, the source may comprise one or more selected from the range of: a coil; an antenna; an intelligent antenna; a loop antenna; a photodetector; a photoresistor; a phototransistors; and a photomultiplier.

The source may comprise a coil. Alternatively, the transmitter may comprise an antenna.

In some embodiments, the system 10 further includes a data input configured to accept external data from an external source. Accordingly, the system 10 may be attached to a communications cable configured to provide data to the system 10.

In one embodiment the processor 16 generates the information based on the measured data and the external data.

In some embodiments, the one or more sensors 42 each comprise a processor 16 having logic configured to determine a parameter of the measurand.

In some embodiments, the system 10 includes a supercapacitor. The supercapacitor may advantageously improve link performance.

In some embodiments, the processor 16 is operable to perform one or more selected from the range of: encryption; data masking; data erasure; data resilience; data authentication not limited to digital ledger and blockchain and volatile memory and traps and self-destruct fuse and auto-destruct fuse and biodegradable materials and chemical release and honeypot techniques.

In some embodiments, LCT includes a supercapacitor, a source transducer including a resonant primary coil, a sink transducer including a resonant secondary coil and a rekoil, sink incorporating impulsive interference suppression, at least one of a source transducer and sink transducer is located in a fluid, wherein a minimum of one of power and information is transferred between the source and a remote sink. The skilled person will understand that the term “rekoil” means a rectifier-coil transducer, which converts induction field to energy for use by the sink. This may improve energy efficiency of the system 10.

In one embodiment a lattice network is provided that includes: a first CSS having a first sink and a first source, the first source configured to transfer a field carrying information; and a second CSS having a second sink and a second source, the second source configured to transduce the field. The at least one CSS is at least partially submerged in a fluid. The first source and the second sink are operable to transfer within a far field signal, said far field corresponding to the region around the source; and wherein a field strength of the signal at an inverse distance (1/r) is greater than the field strength at an inverse distance squared (1/r²) and an inverse distance cubed (1/r³).

In alternative embodiments, the first source and the second sink are operable to transfer information within near field, said near field signal corresponding to a region around the first source where the field strength corresponds to e^{αr} where α is a correction term.

In come embodiments, the network is a mesh network

In some embodiments, the network is asymmetric. For example, the network may comprise a primary/secondary system, a source/replica system, or a provider/consumer system.

In some embodiments, the network further includes a third CSS.

In some embodiments, the network is configured as an edge computing network. In alternative embodiments, the network is configured as a hybrid cloud network.

In some embodiments, the network is configured as an information network such that information is transferred from the first system to the second system, and the second system modifies the information. The information may be modified by removal of a part of the information and/or addition of information from the second system. The modified information may be transferred from the second system to the third system.

In some embodiments, the network is a cabled network configured to transfer information over a low bandwidth information network and uses one or more of LCT and radio and Magneto-Inductive (MI).

In some embodiments, each system is configured to transfer information between a maximum of two other systems. Preferably, one or more of a watchdog timer; a time synchronisation system; and/or a token verification system are used to confirm a failure of the link. Preferably, where a failure has been confirmed, a new configuration is established with a further system based on one or more of: an energy efficiency; a reliability; and a security.

In some embodiments, the first and second systems are attached to a subsea structure above a seabed, and a third system is attached to the subsea structure below the seabed. The attachment may be via an attachment mechanism such as: a magnetic clamp, a suction cup, a strap, a snap bracelet, a Velcro, a hinged clamp, a glue, a weld, and a fastener. Preferably, a field strength of each inter-system link is measured by the respective sensor, the field strength is compared at one or more frequencies, data is derived and processed to calculate the location of the seabed, and the information describing a minimum of one of the extent and rate of and variability of seabed scouring is transferred to a monitoring system.

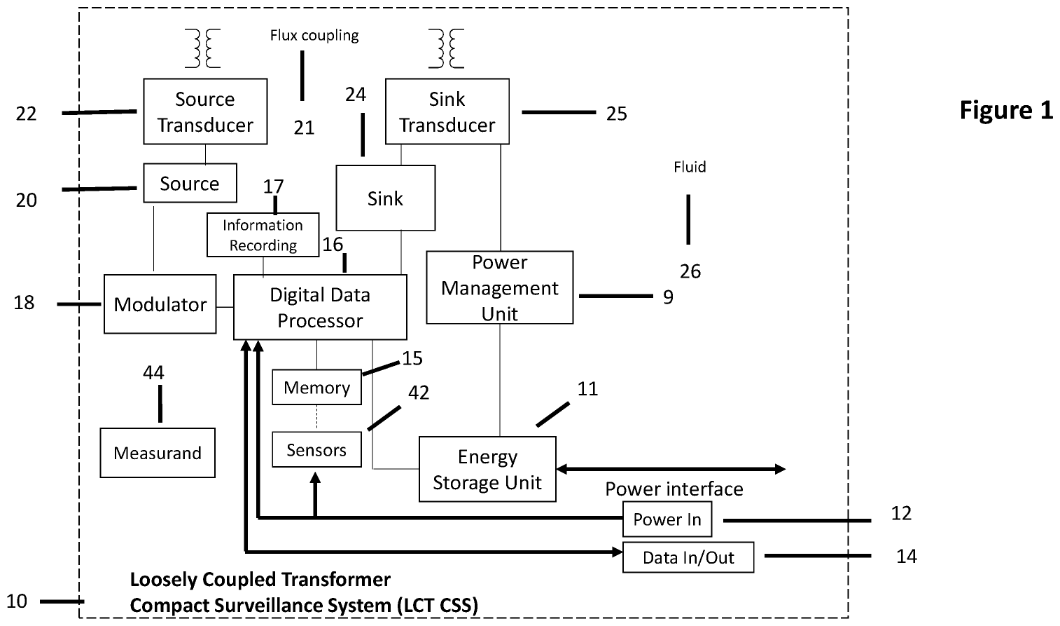

FIG. 1 shows a compact surveillance system (CSS) 10. The CSS 10 includes: a power input 12; a sensor 42; a data input 14; a data memory storage 15; a processor 16, an information storage device 17; a modulator 18, a source transducer 22; and a sink transducer 25.

The sensor 42 is configured to measure a measurand 44. In the present example, the sensor includes two temperature gradient sensors 42 configured to provide a signal indicative of a temperature and/or temperature gradient.

The processor 16 is in electrical communication with: the data input 14; the data memory storage 15; the modulator 18; the information storage device 17; and the sink transducer 25. The processor 16 is configured to receive measurand data from the sensor. The processor 16 is also operable to pre-process and process the data into information. The processor 16 stores the information on the information storage device 17 and generates an information signal representative of the information. For example, the processor 16 is configured to derive one or more selected from the range of: a thermal gradient; a temperature time constant; and a thermal property of the measurand. The information signal is communicated to the modulator 18.

The modulator 18 is in electrical communication with the processor 16 and the source transducer 22. The modulator 18 is configured to receive the information signal generated by the processor 16. The modulator 18 is also configured to superimpose the information on to a field and establish a link between the source transducer 22 and a remote sink transducer 25 across which the information is transferred.

The source transducer 22 is in electrical communication with the modulator 18. The source transducer 22 is configured to detect and convert the modulated signal for transfer to a remote device (not shown). In alternative embodiments, a transmitter may convert the modulated signal into a magneto-inductive signal.

The sink transducer 25 is in electrical communication with the processor 16. The sink transducer 25 may optionally incorporate an intelligent antenna. The sink transducer 25 is configured to detect an external signal from an external source (not shown).

The CSS 10 is at least partially submerged in a fluid 26 such that the sink transducer 25 is submerged in the fluid 26. A link between the source transducer 22 and the sink transducer 25 at least partially traverses the fluid.

The CSS 10 further includes an energy harvesting module. In particular, the CSS 10 further includes a power management unit 9 and an energy storage unit 11. The sink transducer 25 includes a rekoil, said rekoil being in electrical communication with the power management unit 9. The rekoil is configured to convert field energy of the external signal into energy. The energy storage unit 11 is a battery configured to store energy from the rekoil, and release said energy to the CSS 10. The power management unit 9 is a microcontroller configured to govern power functions. For example, the power management unit 9 measures a voltage and/or a discharge and recharge time of the energy storage unit. The power management unit 9 controls power functions and regulates a real time clock. In alternative embodiments, the CSS includes a rectenna.

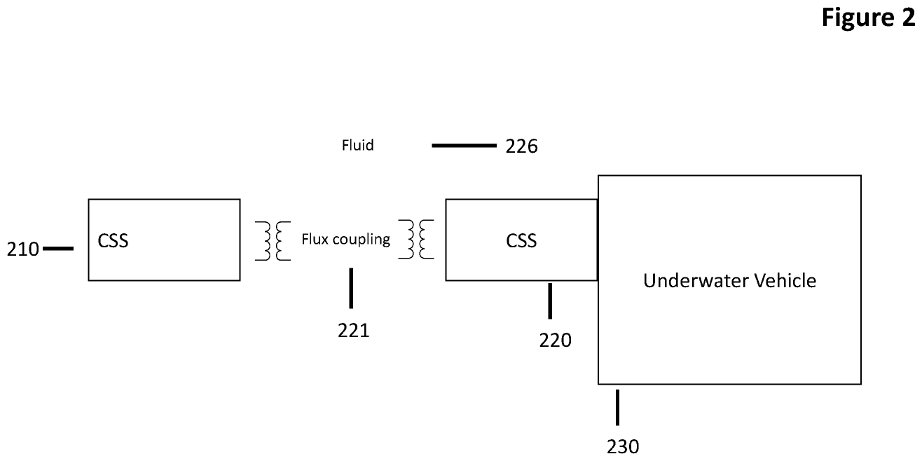

FIG. 2 is a network of compact surveillance systems comprising a first CSS 210 and a second CSS 220. The first CSS 210 and the second CSS 220 are substantially similar to the CSS 10. The first CSS 210 is integrated with an underwater vehicle 230, submerged in a fluid 226, such as water.

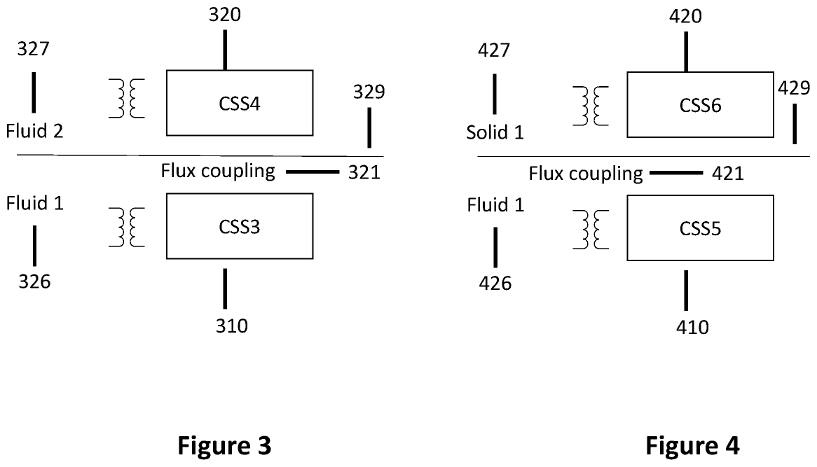

FIG. 3 is a network of compact surveillance systems (CSS) comprising a first CSS 310 and a second CSS 320. The first CSS 310 and the second CSS 320 are substantially similar to the CSS 10. The first CSS 310 is submerged in a first fluid 326, such as water. The second CSS 320 is submerged in a second fluid 327. The first fluid 326 and the second fluid 327 are separated by a fluid boundary 329. The respective transducers of the first CSS 310 and the second CSS 320 are configured such that flux coupling 321 is established between CSS 310 and CSS 320 across boundary 329 across which information is transferred. In one embodiment, the first CSS 310 and the second CSS 320 are positioned such that a field strength of the field at the sink transducer of the second CSS 320 at an inverse distance (1/r) is greater than the field strength at an inverse distance squared (1/r²) and an inverse distance cubed (1/r³).

FIG. 4 is a network of compact surveillance systems comprising a first CSS 410 and a second CSS 420. The first CSS 410 and the second CSS 420 are substantially similar to the CSS 10. The first CSS 410 is submerged in a first fluid 426, such as water. The second CSS 420 is located in or on a solid propagating medium 427. The first fluid 426 and the solid propagating medium 427 are separated by a solid boundary 429. The respective transducers of the first CSS 410 and the second CSS 420 are configured such that flux coupling 421 is established between CSS 410 and CSS 420 across boundary 429 across which information is transferred. In one embodiment, the first CSS 410 and the second CSS 420 are positioned such that a field strength of the signal detected at the sink transducer of the second CSS 420 at an inverse distance (1/r) is greater than the field strength at an inverse distance squared (1/r²) and an inverse distance cubed (1/r³).

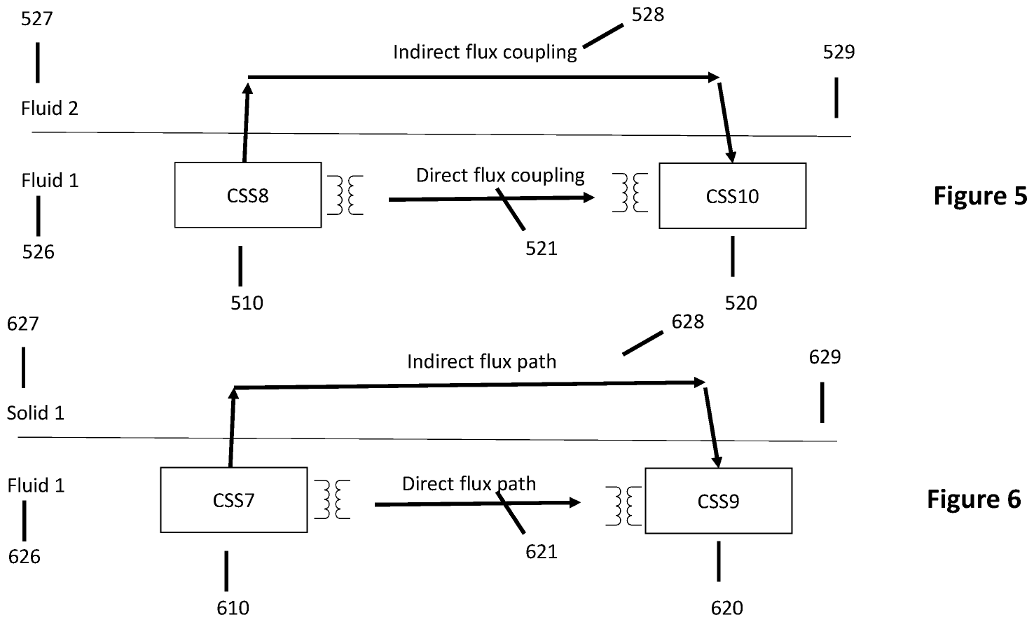

FIG. 5 is a network of compact surveillance systems comprising a first CSS 510 and a second CSS 520. The first CSS 510 and the second CSS 520 are substantially similar to the CSS 10. The first CSS 510 and the second CSS 520 are both submerged in a first fluid 526, such as water. A fluid-fluid boundary 529 separates the first fluid 526 from a second fluid 527. The respective transducers of the first CSS 510 and the second CSS 520 are configured such that flux coupling between a source transducer of the first CSS 510 and a sink transducer of 520 may be one or more of direct and indirect. In the direct flux coupling case, the flux 521 traverses the first medium 526. In the indirect case, the flux 528 traverses the fluid boundary 529, links through the second medium 527, and traverses the fluid boundary 529 from the second medium 529 to the first medium 526.

FIG. 6 is a network of compact surveillance systems comprising a first CSS 610 and a second CSS 620. The first CSS 610 and the second CSS 620 are substantially similar to the CSS 10. The first CSS 610 and the second CSS 620 are both submerged in a fluid 626, such as water. A fluid-solid boundary 629 separates the fluid 626 from a solid propagating medium 627. The respective transducers of the first CSS 610 and the second CSS 620 are configured such that flux coupling between a source transducer of the first CSS 610 and a sink transducer of 620 may be one or more of direct and indirect. In the direct flux coupling case, the flux 621 traverses the first medium 626. In the indirect case, the flux 628 traverses the fluid boundary 629, links through the second medium 627, and traverses the boundary 629 from the second medium 629 to the first medium 626. In one embodiment, the first CSS 610 and the second CSS 620 are positioned such that a field strength of the signal detected at the sink transducer of the second CSS 620 at an inverse distance (1/r) is greater than the field strength at an inverse distance squared (1/r²) and an inverse distance cubed (1/r³). The indirect transmission path 621 is longer than the direct transfer path 627. Transferring through the boundary 629 is sub-optimal.

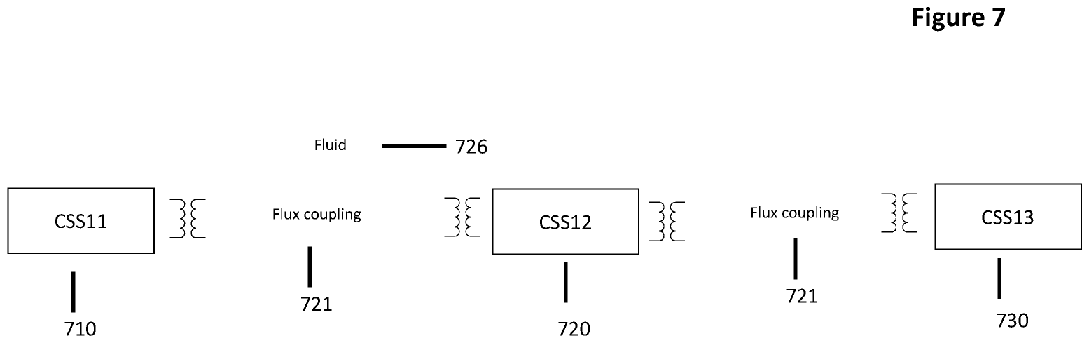

FIG. 7 is a network of compact surveillance systems comprising a first CSS 710, a second CSS 720, and a third CSS 720 submerged in a fluid 726. The first CSS 710, the second CSS 720, and the third CSS 730 are substantially similar to the CSS 10. The first CSS 710 transfers a first information to the second CSS 720. The second CSS 720 modifies, via its processor, the first information so as to include additional information. The second CSS 720 transfers a second information, comprising the first information and the additional information, to the third CSS 730.

The above-mentioned compact surveillance system and networks find particular, but not limited use in offshore structure surveillance, automation and autonomy, environmental surveillance, biodiversity surveillance and holistic companion animal care.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A compact surveillance system (CSS) comprising:
a power input configured to provide power to the system;
one or more sensors configured to measure a measurand;
a receiver configured to receive an external signal; and
a processor configured to generate information, the processor being in one or more of electrical and magnetic communication with:
the one or more sensors;
an information storage device configured to store the information;
a Loosely Coupled Transformer (LCT) transducer configured to transfer the information;
wherein the information is generated based on the measurand so as to reduce a transfer energy.

2. The system of claim 1, wherein the LCT includes:
a supercapacitor.

3. The system of claim 1, wherein the LCT includes:
a source transducer including a resonant primary coil.

4. The system of claim 1, wherein the LCT includes:
a sink transducer including a resonant secondary coil and a rekoil sink.

5. The system of claim 1, wherein the LCT includes impulsive interference suppression.

6. The system of claim 1, wherein the LCT includes:
at least one of a source transducer and a sink transducer.

7. The system of claim 6, wherein the at least one of a source transducer and a sink transducer is located in a fluid.

8. The system of claim 1, wherein a minimum of one of power and information is transferred from source to a remote sink

9. The system of claim 1, wherein the sink comprises:
a sink transducer configured to convert the external signal into an electrical signal;
a rekoil configured to convert field energy of the external signal into electrical energy.

10. The system of claim 9, wherein the rekoil is further configured to capture and convert ambient energy into electrical energy.

11. The system of claim 10, wherein the device further comprises an energy storage unit configured to store the electrical energy captured by the rekoil.

12. The system of any preceding claim, wherein the sink transducer is a smart transducer.

13. The system of any preceding claim, wherein the source unit comprises:
a source transducer having a modulator configured to modulate the information on to a carrier signal;
a source transducer configured to produce a field comprising the modulated signal.

14. The system of any preceding claim, wherein the device further comprises a data storage device configured to store the measurement.

15. The system of any preceding claim, further comprising a data input configured to receive external data from an external source.

16. The system of any preceding claim, wherein the processor generates the information based on the environmental data and the external data.

17. The system of any preceding claim, wherein the one or more sensors each comprise a processor having logic configured to determine a parameter of the measurand.

18. A network comprising:
a first CSS having a first sink and a first source, the first source configured to transfer a signal comprising information; and
a second CSS having a second sink and a second source, the second source configured to detect the signal,
wherein at least one CSS is at least partially submerged in a fluid;

19. The system of claim 18, wherein the network further comprises a third CSS having a third sink and a third source.

20. The system of claim 19, wherein the first CSS is configured to transfer a first information to the second CSS and the second CSS is configured to transfer modified information to the third CSS.

21. The system of claim 20, wherein the modified information is generated by the second CSS, wherein the modified information comprises the first information and an additional information.

22. The system of claim 18, wherein the first source and the second sink are operable to transfer within a far field of said signal, said far field corresponding to the region around the source; and wherein a field strength of the signal at an inverse distance (1/r) is greater than the field strength at an inverse distance squared (1/r²) and an inverse distance cubed (1/r³).
